(19) United States
(12) Patent Application Publication
(10) Pub. No.: US 2016/0179901 A1
(43) Pub. Date: Jun. 23, 2016

(54) Computer-Implemented System And Method For Providing Selective Contextual Exposure Within Social Network Situations

(71) Applicant: Palo Alto Research Center Incorporated, Palo Alto, CA (US)

(72) Inventors: Michael Roberts, Los Gatos, CA (US); Simon Tucker, Oakland, CA (US); Shane Ahern, Foster City, CA (US); John S. Jennings, Heber City, UT (US)

(21) Appl. No.: 14/582,095

(22) Filed: Dec. 23, 2014

(51) Int. Cl. G06F 17/30

(52) U.S. Cl. CPC G06F 17/30528; G06F 17/30864; G06F 17/30958

(57) ABSTRACT

A computer-implemented system and method for providing selective contextual exposure within social network situations is provided. Contextual information is generated for users. A plurality of social relationships is defined between the users and each social relationship is formed between one user and one of the remaining users. A set of graph production rules is applied to the user contextual information for each social relationship between the user and the one of the remaining users. The user contextual information is transformed based on the graph production rules. The transformed user contextual information is copied to the contextual information of the remaining user.

### FIELD

This application relates in general to contextual information sharing and, in particular, to a computer-implemented system and method for providing selective contextual exposure within social network situations.

### BACKGROUND

Graph-based technology is used for a variety of applications. For example, graph databases, such as Neo4j, provided by Neo Technology, Inc., San Mateo, Calif., provide support for storing and querying graphs, typically in property-graph format, where nodes and edges in the graph represent a variety of data. Further, Google Knowledge Graph, provided by Google Inc., Mountain View, Calif., provides a semantically structured knowledge database used by Google for their search engines. In addition, graph-based technology can be found in Maya, three-dimensional computer graphics software, provided by Autodesk, Inc., San Rafael, Calif., and other variety of open source computer graphics software systems, such as Blender, provided by Blender Foundation, Amsterdam, the Netherlands, and Pure Data, provided by Institute of Electronic Music and Acoustics, Graz, Austria. Similarly, graph-technology is used in social networking services, such as Facebook, provided by Facebook, Inc., Menlo Park, Calif., to model social network relationships between users. Such social networks can be queried by a variety of services in the social networking services.

For storing information related to a user's context, graphical models for contextual representation have been previously used. Context is a collection of knowledge of user situations. Contexts can include different types of contextual information, such as physical context, spatial context, social context, electronic social context, and psychological context. Thus, contextual applications can provide relevant contextual information regarding the user in a timely and informative manner based on the understanding of user's current activities. For example, the user's current activities can be determined from user information extracted from social media and sensor data. Context graphs can be created for each user and include rolled-up context for the particular user. Such graphs can be used to provide a variety of interesting services to users.

Privacy concerns associated with user information are extremely high. Contextual graphs can include a variety of information that possibly describes a picture of user's current and past activities, interests, locations, and so on. Such information is susceptible for misuse by others, such as adversary of the user or criminals, so that certain information in the contextual graphs must be kept private. Simple access restrictions to contextual applications can prevent others from accessing to user's personal information. However, such solution does not solve privacy concerns in social networking web or mobile applications where contextual information is exposed between users.

Therefore, there is a need for selectively exposing user contextual information to others in social networking situations.

### SUMMARY

An embodiment provides a computer-implemented system and method for providing selective contextual exposure within social network situations. Contextual information is generated for users. A plurality of social relationships is defined between the users and each social relationship is formed between one user and one of the remaining users. A set of graph production rules is applied to the user contextual information for each social relationship between the user and the one of the remaining users. The user contextual information is transformed based on the graph production rules. The transformed user contextual information is copied to the contextual information of the remaining user.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a functional block diagram showing a computer-implemented system for providing selective contextual exposure within social network situations, in accordance with one embodiment.

FIG. 2 is a flow diagram showing a computer-implemented method for providing selective contextual exposure within social network situations, in accordance with one embodiment.

FIG. 3 is a flow diagram showing a routine for generating contextual information for a user using semantic graphs for use in the method of FIG. 2.

FIG. 4 is a process flow diagram showing, by way of example, semantic representation for use in the method of FIG. 3.

FIG. 5 is a flow diagram showing a routine for selectively exposing contextual information for use in the method of FIG. 2.

FIG. 6 is a graph showing, by way of example, activities performed by a user in the Palo Alto area.

FIG. 7 is a flow diagram showing a routine for transferring user contextual information to semantic graphs for the others in the social network for use in the method of FIG. 2.

FIG. 8 is a process flow diagram showing, by way of example, a semantic relationship in a social network.

### DETAILED DESCRIPTION

A platform for contextual applications processes contextual data in a real time and supports contextual applications for mobile applications, as described in commonly-assigned U.S. patent application, entitled “Generalized Contextual Intelligence Platform,” Ser. No. 13/873,061, filed Apr. 29, 2013, pending, the disclosure of which is incorporated by reference. Each time when contextual data for a user is collected, the contextual data is applied to a context graph or semantic graph describing the user's current state. Thus, real-time processing of contextual data of the user can provide relevant contextual information at the very moment that the user is engaged in a particular activity. However, adopting such a contextual intelligence platform to social networking Web applications is still uninvestigated.

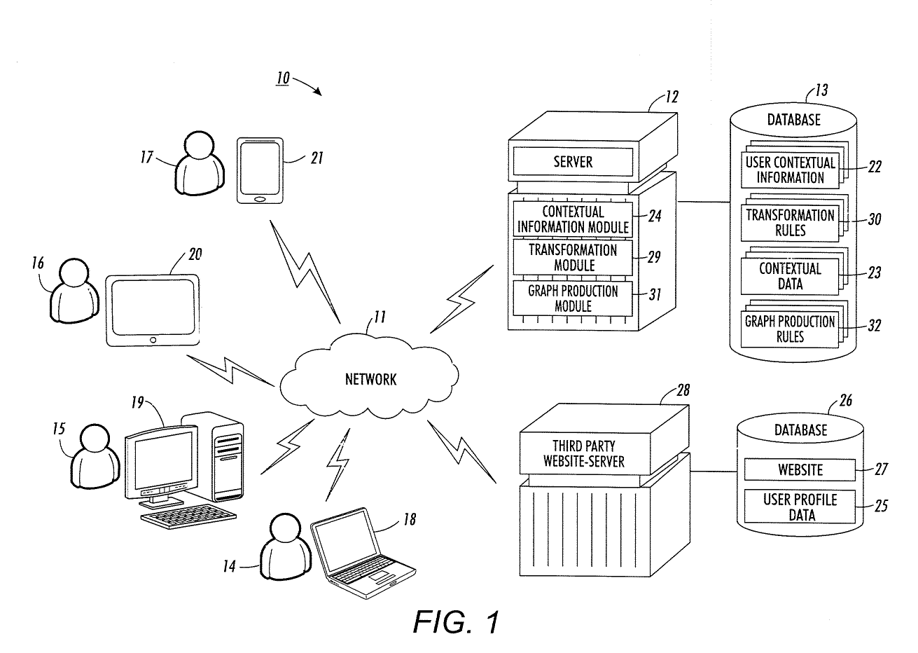

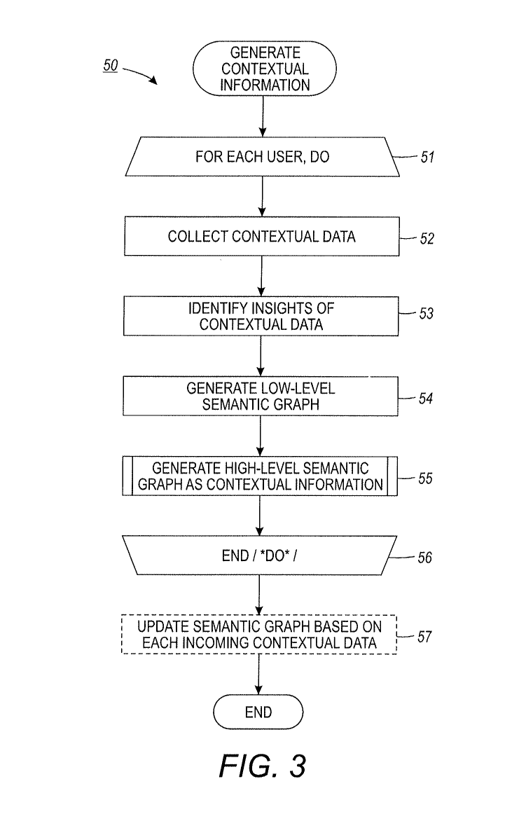

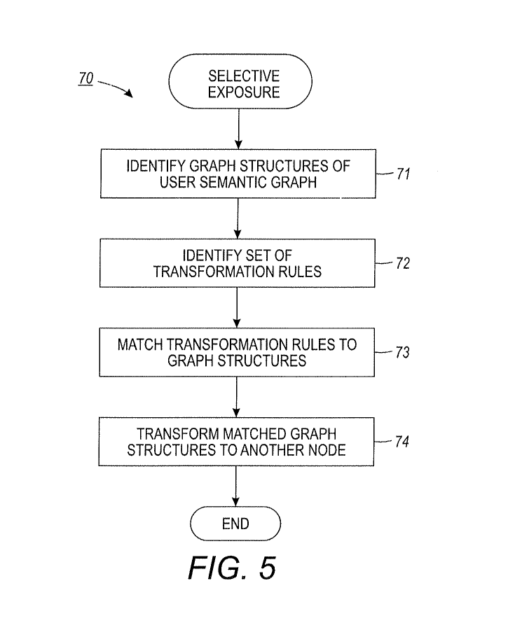

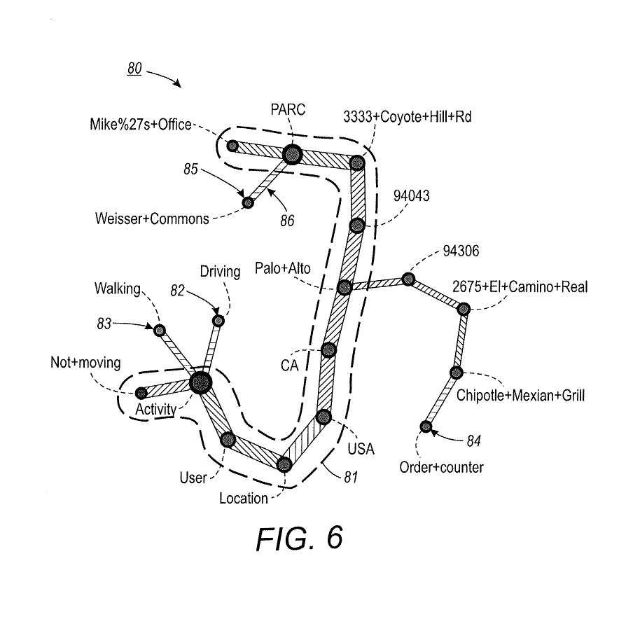

Selectively exposing contextual information between users in social networking situations can be accomplished by abstracting user contextual information when transferring the user contextual information to other's contextual information. FIG. 1 is a functional block diagram showing a computer-implemented system 10 for providing selective contextual exposure within social network situations, in accordance with one embodiment. Users 14, 15, 16, 17 in the current system access a third party Website 27 stored in a database 26 interconnected to a third-party Website server 28 via a network 11 through stationary computers 18, 19 or mobile computers 20, 21. A server 12 first collects contextual data 23 for each user 14, 15, 16, 17 from various sources, such as from user profile data 25 stored in a database 26 for a third-party Websites 28, the activities of the user performed through mobile or stationary computers 18, 19, 20, 21, or physical data regarding the user recorded through the mobile or stationary computers 18, 19, 20, 21. A contextual information module 24 generates user contextual information 22 for the user and stores the user contextual information 22 in the database 13, as further described infra with reference to FIG. 3. The server 12 further identifies social networks (not shown) for the user 14, 15, 16, 17 including a set of groups of individuals, such as family, friends, and so on, typically stored as user profile data 25 for the third party Website 27. A transformation module 29 transforms a fraction of the user contextual information 22, such as graph structures of the user contextual information to another graph structure based on a set of transformation rules 30, as further described infra with reference to FIGS. 5 and 6. A structure of the user contextual information 22 can be copied to the other's user contextual information 22 based on a set of graph production rules 32 by a graph production module 31. Once the transformed user contextual information is copied to the other's user contextual information, the user contextual information can be displayed in a way that privacy is preserved.

Each computer 18, 19, 20, 21 includes components conventionally found in general purpose programmable computing devices, such as essential processing unit, memory, input/output ports, network interfaces, and known-volatile storage, although other components are possible. Additionally, the computers 18, 19, 20, 21 and the server 12 can each include one or more modules for carrying out the embodiments disclosed herein. The modules can be implemented as a computer program or procedure written as a source code in a conventional programming language and is presented for execution by the central processing unit as object or byte code or written as inter-credit source code in a conventional interpreted programming language inter-credit by a language interpreter itself executed by the central processing unit as object, byte, or inter-credit code. Alternatively, the modules could also be implemented in hardware, either as intergraded circuitry or burned into read-only memory components. The various implementation of the source code and object byte codes can be held on a computer-readable storage medium, such as a floppy disk, hard drive, digital videodisk (DVD), random access memory (RAM), read-only memory (ROM), and similar storage mediums. Other types of modules and module functions are possible, as well as other physical hardware components.

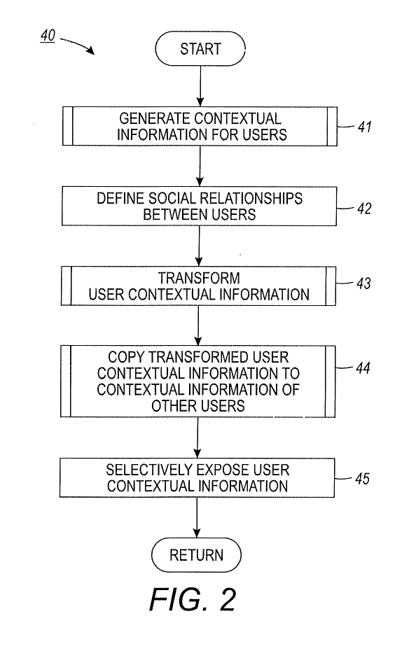

Transforming graphical structure of user contextual information provides a level of security between users within social network situations. FIG. 2 is a flow diagram showing a computer-implemented method 40 for providing selective contextual exposure within social network situations, in accordance with one embodiment. In forming social networks between users, contextual information is created for each user from a collection of contextual data, as further described infra with reference with FIG. 3 (step 41). The contextual information can be continuously generated and updated when new incoming contextual data is collected. Other examples of timing for generating or updating the contextual information are possible.

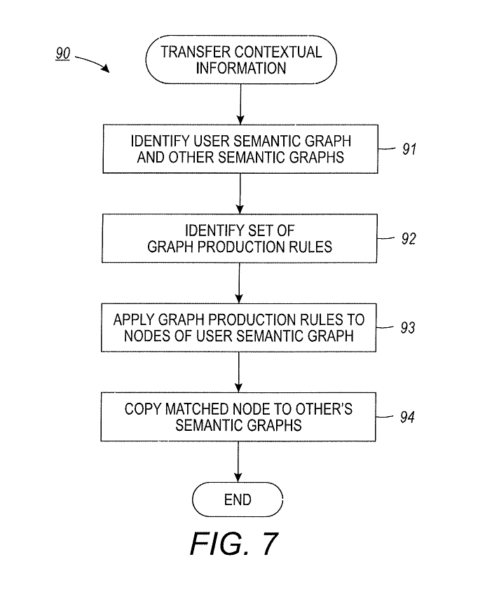

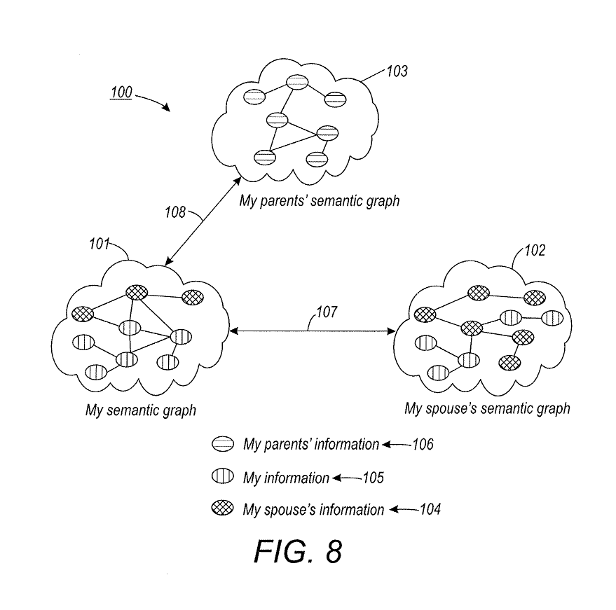

As a part of user contextual information, social networks for the user are usually identified (step 42). The social networks are formed with individuals, each of whom has a certain relationship with the user, and may include categories of individuals, such as “friends,” “family,” and “close friends.” In a situation where user contextual information is transmitted to others in the social networks, the abstracted user contextual information, such as higher concept of the fraction of the user contextual information, based on a set of transformation rules can be shared to others (step 43), as further described infra with reference to FIGS. 5 and 6. With or without abstraction of the user contextual information, a fraction of the user contextual information can be copied to contextual information for others in the social network (step 44), as further described infra with reference to FIGS. 7 and 8. By copying the abstracted contextual information, the user contextual information is selectively exposed to others in the social network (step 45). In a further embodiment, the abstracted contextual information can be associated with a file, such as media files, to further process the media files based on the contextual information, such as described in commonly-assigned U.S. patent application, entitled “Computer-Implemented System and Method for Providing Contextual Media Tagging for Selective Media Exposure,” Ser. No. ______, filed on ______, pending, the disclosure of which is incorporated by reference.

User contextual information can be generated using semantic graphs. Semantic graphs can represent contextual information of the user in a set of semantic relationships. FIG. 3 is a flow diagram showing a routine 50 for generating contextual information for a user using semantic graphs for use in the method of FIG. 2. For creating contextual information for each user (step 51), first, contextual data regarding the user is collected (step 52). The contextual data can be a variety of data collected from different sources and supports building context graphs for each user, as described in commonly-assigned U.S. patent application, entitled “Generalized Contextual Intelligence Platform,” Ser. No. 13/873,061, filed Apr. 29, 2013, pending, the disclosure of which is incorporated by reference. In one embodiment, the contextual data can include low-level event data regarding the user. For example, the low-level event data can include user's walking, running, sitting, and not moving, or semantic location information provided by reverse geocoding, such as showing that the user is located in a park. For another example, the low-level event data can include physical activity data of the user detected from devices, such as sensor and accelerometers. Further, the contextual data can include user profile data on third party social media sites, such as Facebook, Twitter, provided by Twitter, Inc., San Francisco, Calif., LinkedIn provided by LinkedIn Co., Mountain View, Calif., or emails of the user. The contextual data from the social media sites can include user's identity information, likes and dislikes, networks, user interests, pictures, videos, sound recordings, posts, and activities within the third party Website. Other types of low-level event data are possible.

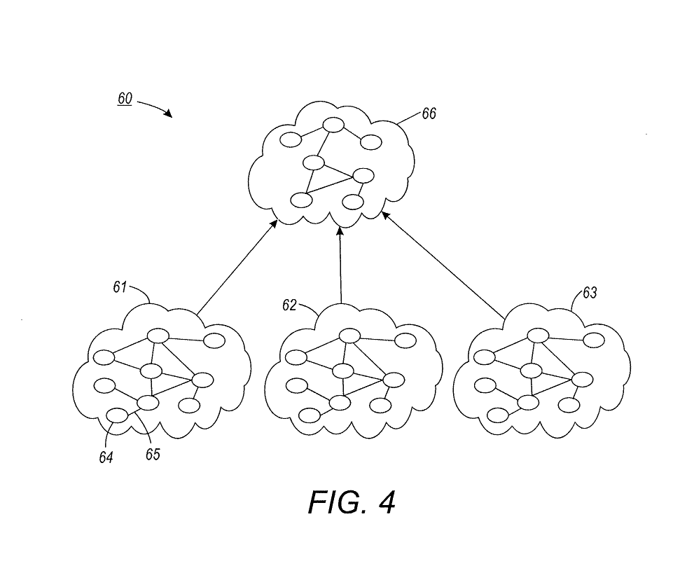

The collection of the contextual data regarding the user is further processed to identify insights of the contextual data (step 53). The identified insights for the user can be usually represented in a semantic graph. Based on the identified insights, a low-level semantic graph is generated (step 54). For example, a low-level semantic graph can include insights, such as “Mary is in a parking lot,” “she is walking,” and “the time is close to the time when she usually leaves work.” By combining and lifting these insights, a high-level semantic graph can be created (step 55). For the earlier example of Mary's activities, the high-level semantic graph can include an insight such as “Mary is leaving work.” By way of example, FIG. 4 is a process flow diagram showing semantic representation 60 for use in the method of FIG. 3. Low-level semantic graphs 61, 62, 63 are formed with nodes 64 and edges 65. Insights from each low-level semantic graph 61, 62, 63 are collected and the collection creates a high-level semantic graph 66. In this way, each contextual information for each user can be created (step 56). The semantic graphs for the users are usually temporary stored in a database or in memory and can be updated based on each incoming new contextual data as necessary (step 57).

For each user, a social network is usually formed based on a “friends” network or groups created through third-party Websites, such as general social media sites. As an example of a social media site, Facebook creates a “friends” network for each user by connecting the user and other users on Facebook. Typically, the other users in the “friends” network can have access to components of the user's Facebook Webpage. The user may manually change a level of access to the components of the user's Webpage for each individual. In one embodiment, the social network for the user can be built based on at least one of “friends” networks or groups. In a further embodiment, the social networks can be built on multiple “friends” networks and groups. Further, the social network can be categorized as “friends,” “family,” “work,” and so on. Other methods of generating a social network for a user are possible.

A user can limit the exposure levels of user contextual information to other individuals by specifying rules that transform insights of the user contextual information into higher-level concepts. FIG. 5 is a flow diagram showing a routine 70 for selectively exposing contextual information for use in the method of FIG. 2. A user can abstract potentially sensitive user contextual information to a more general semantic representation based on graph structures. Abstraction of user contextual information can start from identifying graph structures of a user semantic graph (step 71). By way of example, FIG. 6 is a graph 80 showing activities performed by a user in the Palo Alto area. The graph 80 contains various nodes 82, 83, 84, 85 and edges 86. Each node 82, 83, 84, 85 describes each different user contextual information regarding the user. In one embodiment, locational user information can be described as a chain of location nodes or structural pattern of locational nodes. In this example, a chain of nodes 81 contains nodes, such as “Location,” “Palo Alto,” “3333+Coyote+Hill+Road,” “Not Moving,” and so on, and are connected with edges as a main branch in the graph. Other types of graph structures are possible.

Referring back to FIG. 5, once the graph structures of the user semantic graph are identified, a set of transformation rules for transforming each graph structure is identified (step 72). The transformation rules define how to transform each of the graph structures of the user semantic graph to another node. The transformation rules can apply to each graph structure of the user semantic graph (step 73). In one embodiment, such transformation can be based on a hierarchy of categories of nodes and replace a low-level concept to a higher-level concept. For example, a hierarchy of node categories can include a category of work, home, restaurant, and so on as a high-level node category and an address or coordinates of each location of work, home, and restaurant can be located in a hierarchy tree as subcategories of the work, home, and restaurant categories. Thus, transformation rules can state that a specific address or coordinates can be replaced to work, home, and restaurant. In a further embodiment, transformation rules can state that a certain structural pattern of the user semantic graph can be replaced to a higher-level concept node. In a still further embodiment, transformation rules can replace a certain chain of nodes to a node with higher-level of semantic concept. Other types of transformation rules are possible. Referring back to the example of FIG. 6, processing of the main branch chain of nodes can generate user information that the user is at 3333 Coyote Hill Road, Palo Alto now and not moving. In this example, the transformation rule can be indicated as “User→Location→PARC→3333 Coyote Hill Road→Palo Alto→California-USA: User→Location→Work.” Thus, the chain of nodes will be replaced to “Work” node. Further, other nodes 82, 83, 84, 85 in the user semantic graph can include further information regarding the user. For example, sub branches in this example containing nodes “Driving,” 82, “Walking,” 83, and “Weisser+Commons,” 85 are not extending with other nodes and could mean that the user is currently neither “walking,” “driving,” nor “at Weisser Commons.” Further, a smaller branch including “Order+counter” node 84 can mean that the user was in the past performed the activity going to Chipotle Mexican Grill at 2675 El Camino Real and ordering at the counter. Other graph mechanisms are possible.

Referring back to FIG. 5, the graph structure matched with one of the transformation rules is then transformed to another node (step 74). The transformation can occur only to the selected graph structure so that the rest of the graph structures in the semantic graph will not be changed. The transformation can be performed for any type of user contextual information, such as home locations, activities, and interests. In this way, replacing a low-level concept to a high-level concept in the semantic graph can abstract user contextual information. Such abstraction can patch the high-level concept, such as a single node, on the low-level concept, such as multiple nodes with a structure, rather than redrawing new user semantic graph.

Insights of the user semantic graph can be transferred to the semantic graphs for others in the social network for sharing. By transferring, the semantic graph for the others in the social network accurately reflects contextual information of the user. The insights of the user semantic graph can be transferred to the other's semantic graphs continuously whenever the user semantic graph is updated by receiving new incoming contextual data. As the user semantic graph can be formed as a low-level semantic graph and high-level semantic graph, the semantic graphs for the others in the social network can be formed as a low-level semantic graph or high-level semantic graph. FIG. 7 is a flow diagram showing a routine 90 for transferring user contextual information to semantic graphs for the others in the social network for use in the method of FIG. 2. First, a semantic graph for the user and semantic graphs for the others in the user's social network are identified (step 91). By way of example, FIG. 8 is a process flow diagram showing a semantic relationship 100 in a social network. A semantic graph 101 generated for a user can contain the most recent contextual information regarding the user. Similarly, a semantic graph for a spouse 102 and semantic graph for parents 103 contains their own contextual information. Referring back to FIG. 7, the insights of the user semantic graph can be transferred to other semantic graphs based on a set of graph production rules (step 92). The graph production rules define how user contextual information is copied between the semantic graphs. In one embodiment, the graph production rules can be generated for each individual in the social network. For example, a set of graph production rules can state that user contextual information such as information regarding home and family life can be copied to parents and close friends, but not to general friends. As another example, a set of graph production rules can state that work related contextual information can be only copied to colleagues of the user. The graph production rules are then applied to the user semantic graph, specifically nodes of the user semantic graph (step 93). By applying the graph production rules, a node of a user semantic graph can be copied to the other's semantic graph so that the semantic graph of the others will now include the copied node in the semantic graph (step 94). In a further embodiment, graph production rules first detect graph structures of the user semantic graph and determine a meta-node representing the graph structures so that the graph structures of the user semantic graph can be copied. For instance, a set of graph production rules can state, “when a node describing a user's location in a semantic graph is identified, the node will be copied to the other's semantic graphs” and the location information of the first user will be exposed to the second user. Referring back to FIG. 8, based on the graph production rules 107, 108, my semantic graph 101 can contain nodes regarding my information 105 and my spouse's information 104 by creating nodes derived from my spouse's graph. My spouse's semantic graph 102 can similarly contain nodes regarding my spouse's information 104 and my information 105 derived from nodes in my graph. My parents' semantic graph 103 can contain nodes of my parent's information 106 and my information 105 by copying nodes of my nodes. In this way, the media file can be shared to other individuals in the social network when the user contextual information is copied to the user contextual information of the other individuals. Other mechanisms for sharing the media file associated with the user contextual information are possible.

While the invention has been particularly shown and described as referenced to the embodiments thereof, those skilled in the art will understand that the foregoing and other changes in form and detail may be made therein without departing from the spirit and scope of the invention.

What is claimed is:

1. A computer-implemented system for providing selective contextual exposure within social network situations, comprising:
a contextual information module configured to generate contextual information for users;
a relationship module configured to define a plurality of social relationships between the users, each social relationship being formed between one user and one of the remaining users;
a graph production rule module configured to apply a set of graph production rules to the user contextual information for each social relationship between the user and the one of the remaining users;
a transformation module configured to transform the user contextual information based on the graph production rules; and
a copying module configured to copy the transformed user contextual information to the contextual information of the remaining user,
wherein a non-transitory computer readable storage medium storing code for executing on a computer system to perform the method steps.

2. A system according to claim 1, further comprising:
a contextual data module configured to collect contextual data regarding the user;
an insight identification module configured to identify insights of the contextual data of the user; and
a semantic graph module configured to generate semantic graphs for the user and the remaining users comprising a plurality of nodes and edges that create graph structures.

3. A system according to claim 2, further comprising:
a transformation matching module configured to match the transformation rules to each graph structure of the user semantic graph; and
a transformation module configured to transform the matched graph structure to a single node.

4. A system according to claim 3, further comprising:
a hierarchy of node categories maintained in the database comprising high level node categories and low level node categories corresponding to each high level node category as sub node categories;
the transformation rule module configured to define the transformation rule as replacing the low level node categories to the high level node category corresponding to the low level node categories;
a graph transformation module configured to apply the transformation rules to each chain of nodes of the user semantic graph; and
a replacement module configured to replace the chain of nodes as the low level node categories to the single node which is a high level node category corresponding to the low level node categories.

5. A system according to claim 2, further comprising:
a relationship analysis module configured to analyze the social relationship between the user and the remaining user; and
a rule selection module configured to identify one of the transformation rules to apply to the user semantic graph based on the analysis of the social relationship.

6. A system according to claim 2, wherein the graph structures comprise at least one of a chain of nodes, pattern of the semantic graph, and shape of the semantic graph.

7. A system according to claim 2, further comprising:
a graph production rule module configured to define a set of graph production rules for the user semantic graph;
a graph production matching module configured to match each graph production rule to each graph structure of the user semantic graph; and
a graph structure replacement module configured to replace the matched graph structure to a part of the semantic graph of the contextual information of the remaining user.

8. A system according to claim 7, wherein each of the set of graph production rules apply to each individual of the remaining users.

9. A system according to claim 2, further comprising:
an incoming context module configured to recognize incoming new contextual data regarding the user; and
an update module configured to update the user contextual information based on the incoming new contextual data.

10. A system according to claim 1, further comprising:
a social network module configured to generate social relationships between the users based on social networks obtained from third party Websites.

11. A computer-implemented method for providing selective contextual exposure within social network situations, comprising:
generating contextual information for users;
defining a plurality of social relationships between the users, each social relationship being formed between one user and one of the remaining users;
for each social relationship between the user and the one of the remaining users, applying a set of graph production rules to the user contextual information;
transforming the user contextual information based on the graph production rules; and
copying the transformed user contextual information to the contextual information of the remaining user,
wherein a non-transitory computer readable storage medium storing code for executing on a computer system to perform the method steps.

12. A method according to claim 11, further comprising:
collecting contextual data regarding the user;
identifying insights of the contextual data of the user; and
generating semantic graphs for the user and the remaining users comprising a plurality of nodes and edges that create graph structures.

13. A method according to claim 12, further comprising:
matching the transformation rules to each graph structure of the user semantic graph; and
transforming the matched graph structure to a single node.

14. A method according to claim 13, further comprising:
maintaining a hierarchy of node categories in the database comprising high level node categories and low level node categories corresponding to each high level node category as sub node categories;
defining the transformation rule as replacing the low level node categories to the high level node category corresponding to the low level node categories;
applying the transformation rules to each chain of nodes of the user semantic graph; and
replacing the chain of nodes as the low level node categories to the single node which is a high level node category corresponding to the low level node categories.

15. A method according to claim 12, further comprising:
analyzing the social relationship between the user and the remaining user; and
identifying one of the transformation rules to apply to the user semantic graph based on the analysis of the social relationship.

16. A method according to claim 12, wherein the graph structures comprise at least one of a chain of nodes, pattern of the semantic graph, and shape of the semantic graph.

17. A method according to claim 12, further comprising:
defining a set of graph production rules for the user semantic graph;
matching each graph production rule to each graph structure of the user semantic graph; and
replacing the matched graph structure to a part of the semantic graph of the contextual information of the remaining user.

18. A method according to claim 17, wherein each of the set of graph production rules apply to each individual of the remaining users.

19. A method according to claim 12, further comprising:
recognizing incoming new contextual data regarding the user; and
updating the user contextual information based on the incoming new contextual data.

20. A method according to claim 11, further comprising:
generating social relationships between the users based on social networks obtained from third party Websites.
